(19) United States
(12) Patent Application Publication
(10) Pub. No.: US 2017/0023980 A1
(43) Pub. Date: Jan. 26, 2017

(54) LAPTOP COVER

(71) Applicant: Scarlee Marseille, Brockton, MA (US)

(72) Inventor: Scarlee Marseille, Brockton, MA (US)

(21) Appl. No.: 14/806,180

(22) Filed: Jul. 22, 2015

(51) Int. Cl. G06F 1/16

(52) U.S. Cl. CPC G06F 1/1656; G06F 1/1637; G06F 1/1616

(57) ABSTRACT

A laptop cover being attachable to a top display portion of a laptop. The laptop cover having a slideable panel capable of sliding outward to a left or right of the laptop to allow for holding of a paper, papers, additional computer displays, and the like.

### BACKGROUND OF THE INVENTION

Field of the Invention

The present invention relates generally to laptop covers. More particularly the present invention relates to a laptop cover device having a sliding panel to allow documents, media, multi-media, and the like to be displayed adjacent to the laptop screen.

Description of Related Art

When working on a laptop or other computer, there is often a need to display multiple documents at a time. These documents may be printed on paper, or displayed on a screen. When the documents are in a paper format, typically a user has to move their head and eyes away from the screen down to the desk that they are working on, at best. This causes slowed work flow, confusion, and can lead to errors and frustration.

When the documents are in a digital format and displayed on the screen, the user is limited by space on the screen. Typically, especially with laptop monitors, only one or two documents can be displayed at a time. Adding more windows on a screen leads to a cumbersome switching between document windows. This again can cause slowed work flow, confusion, and can lead to errors and frustration.

In some cases, a solution to the above problem has been to connect multiple monitors to a single computer, allowing for a composite larger display. This may work in some desk embodiments, but is typically not practical for laptop and mobile use.

Therefore, what is needed is a device that may connect to a back of a laptop screen having a slideable panel that may extend to one side or another to hold papers, another display, or some other media/multi-media.

### SUMMARY OF THE INVENTION

The subject matter of this application may involve, in some cases, interrelated products, alternative solutions to a particular problem, and/or a plurality of different uses of a single system or article.

In one aspect, a laptop computer cover is provided. The cover is formed of a body and a slideable panel positioned within a spacing defined by the body. The body has lengthwise and widthwise edges, and a portion of the body extends between the two lengthwise edges somewhat upwardly between the edges. A spacing is defined between the body and the lengthwise and widthwise edges. The body is sized and configured to be attached to a display (top) portion of a laptop computer. The slideable panel is slidably positioned within the spacing. This panel is slideable between a number of positions, including a first position centered on the body in the spacing with no portion of the slideable panel extending beyond the widthwise edges; a second position having a first part of the slideable panel within the spacing and a second part of the slideable panel extending beyond one widthwise edge; and a third position having the first part of the slideable panel extending beyond the other widthwise edge, and the second part within the spacing. As such, the slideable panel is slideable in two directions towards each of the opposite widthwise edges—corresponding to each side (left and right) of the laptop when attached.

In another aspect, a laptop computer is provided having a case with a slideable panel for holding papers, displays, and other media/multimedia adjacent to a screen of a laptop. The laptop computer comprises a display portion housing a display, and a lower body part hingedly connected to the display portion. A cover is attached to the laptop computer display portion. This cover has a body, and a slideable panel positioned within a spacing defined by the body. The body has lengthwise and widthwise edges, a portion of the body extends between the two lengthwise edges. A spacing is defined between the body and the lengthwise and widthwise edges. The body is sized and configured to be attached to a display (top) portion of a laptop computer. The slideable panel is slidably positioned within the spacing. This panel is slideable between a number of positions, including a first position centered on the body in the spacing with no portion of the slideable panel extending beyond the widthwise edges; a second position having a first part of the slideable panel within the spacing and a second part of the slideable panel extending beyond one widthwise edge; and a third position having the first part of the slideable panel extending beyond the other widthwise edge, and the second part within the spacing.

In yet another aspect, a laptop computer cover is provided. The cover is formed of a body and a slideable panel positioned within a spacing defined by the body. A display screen is integrated to the slideable panel. The cover further includes a connector allowing the display of the panel to be attached to a video output of the laptop computer. The body forms a spacing defined between the body and the lengthwise and widthwise edges. The slideable panel is slidably positioned within the spacing and is capable of many slideable positions with respect to the body and the laptop to which the body is configured to be attached. As such, the slideable panel is slideable in two directions towards each of the opposite widthwise edges—corresponding to each side (left and right) of the laptop when attached. In some embodiments, the laptop computer may be configured to adjust what is displayed by the display of the slideable panel based on a position of the slideable panel.

### BRIEF DESCRIPTION OF THE DRAWINGS

FIG. 1 provides a perspective view of an embodiment of the present invention.

FIG. 2 provides a view of an embodiment of the present invention attached to a laptop and in an extended position.

FIG. 3 provides a view of an embodiment of the present invention in an extended position.

FIG. 4 provides a view of another embodiment of the present invention in an extended position.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Some embodiments of the present invention may be practiced on a computer system that includes, in general, one or a plurality of processors for processing information and instructions, RAM, for storing information and instructions, ROM, for storing static information and instructions, a data storage unit such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified herein. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified herein.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Generally, the present invention concerns laptop computer cover having a slideable panel that can be extended beyond a side edge of the laptop monitor. The slideable panel may be configured to hold one or multiple sheets of paper in one embodiment. In another embodiment, the slideable panel may be configured to hold a secondary display such as a tablet computer. In still another embodiment, the slideable panel may contain its own display configured to be a continuation of, or supplement to, the laptop display.

The laptop cover contemplated herein generally comprises a body for attaching to a display portion of a laptop computer (that being the top portion of the foldable laptop, which houses the display of the laptop). A slideable panel is slidably mounted to the body such that it can be slid from side to side, in either direction. A portion of the body extends over the slideable panel, holding it in place. In one embodiment, a majority of the slideable panel may be covered by the body extending over it, with a part of the slideable panel exposed on each lengthwise side end. This allows a user to access the slideable panel on each side, to pull it outward. The single piece slideable panel is then drawn outward in one direction or another.

On the slideable panel, there may be one or more accessories to facilitate its use. These accessories may include clips such as paper clips of any type, flip out holders, embedded tools, and the like. Similarly, there may be one or more accessories connected or integrated with the body. These accessories may include a display connection to the computer (in embodiments having a supplemental display on or in the slideable panel), pens, styluses, data storage devices (such as a USB storage device), credit card readers, laser pointers, a smartphone stand using a credit card as a base, and the like.

The body may attach to the laptop display portion in any manner capable of securing it in place. In one embodiment, a plurality of tabs may extend inwardly from an outer edge of the body. These tabs may snap over the perimeter of the laptop display portion, allowing the body to be removably held in place. In other embodiments, any manner of securing the body to the laptop display portion may be employed without straying from the scope of this invention.

In further embodiments, the laptop cover may have a lower body part that attaches to a bottom, keyboard portion of the computer. In this embodiment, the lower body part provides protection to the bottom, keyboard portion of the computer. The lower body part may be attached to the body, or may be separate from it.

The invention contemplated herein may be formed of any material capable of being attached to the laptop. Examples of materials of which the invention may be formed include, but are not limited to: metals, plastics, composite materials, and the like.

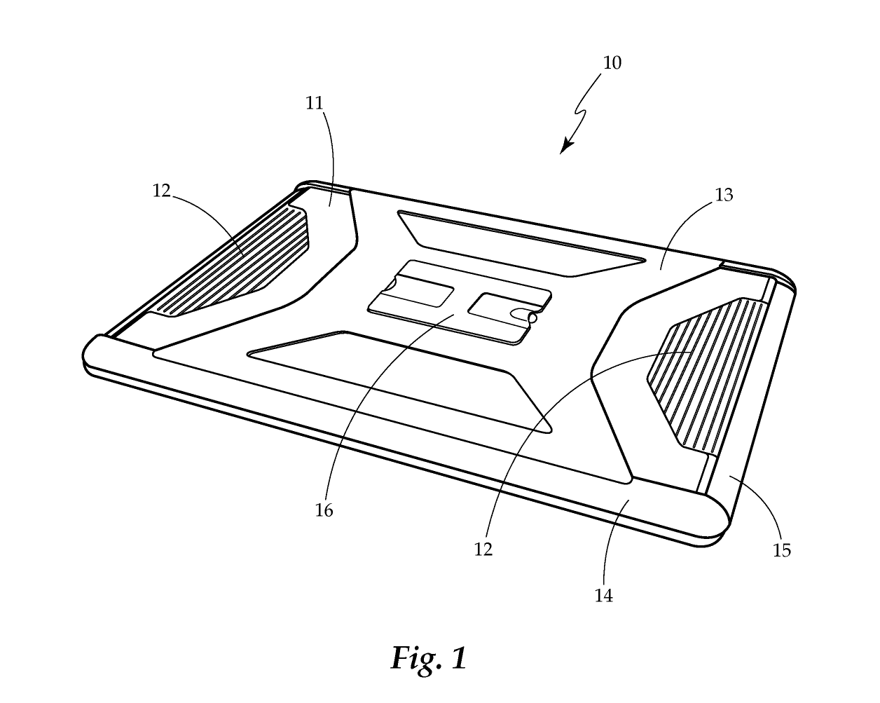

Turning now to FIG. 1, a perspective view of a top of the present invention is provided. The laptop cover 10 has a body 13 with edges 14 and 15. The body 13 is formed to fit about a display portion of a laptop (not shown). Edges 14, 15, define the ends of the body 13, and in most embodiments are sized to accommodate and connect to the laptop display portion. Body 13 also extends upward between lengthwise edges 14 to define a spacing in which slideable panel 11 is slidably secured. Slideable panel 11 is formed as a generally flat, rectangular sheet (though its shape may vary within the scope of the invention). This sheet extends over most, but not all of the body 13. On opposite lengthwise edges 12 is a textured area. The textured area may provide a grip for a user to draw the slideable panel 11 in either direction. In other embodiments, the textured area may provide flexibility to the sheet. The body 13 extending over the slideable panel 11 has a shape that tapers inward from edges 14 towards the center, at the center, the shape is generally rectangular, and again tapers to the other edge. In the rectangular area is a removable accessory set 16. These accessories may include items such as a portable storage device, laser pointer, stylus, credit card reader, smartphone stand, and the like. On a front of the slideable panel (not shown in this figure), there may be structure for holding papers in place, for holding a display, or a display integrated into the slideable panel 11.

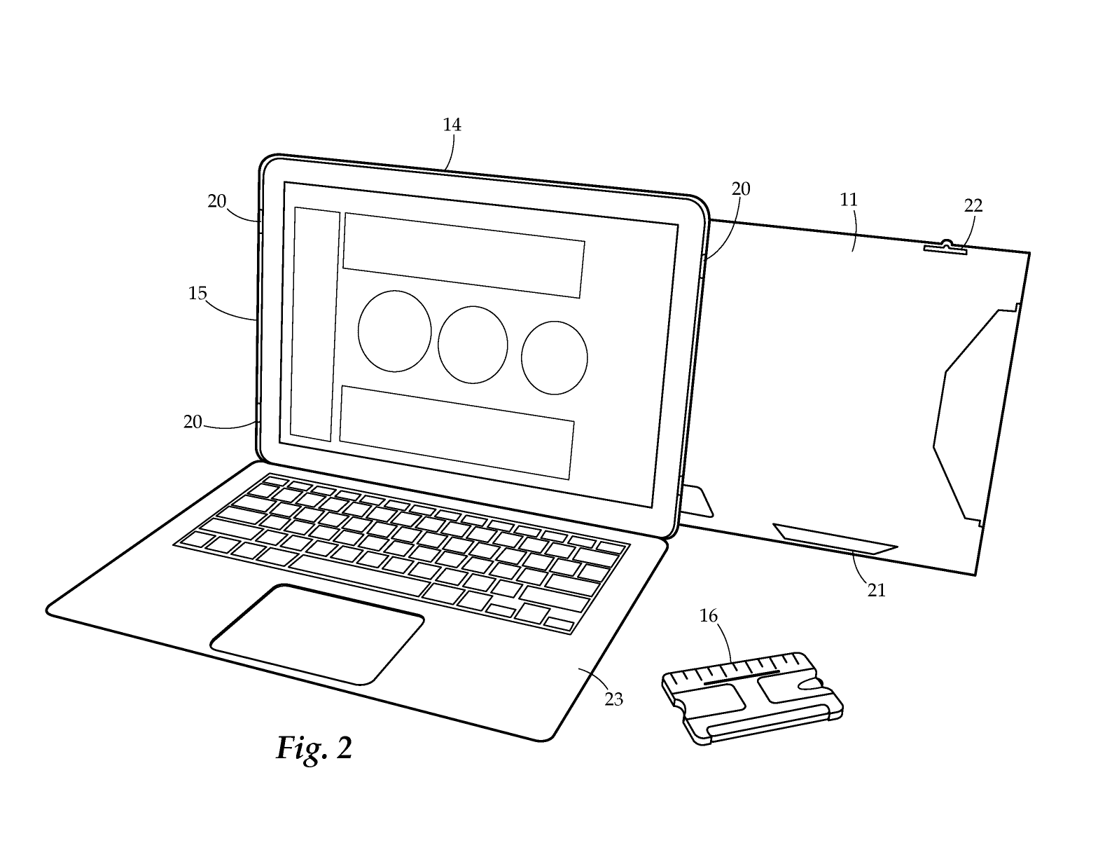

FIG. 2 shows another embodiment of present invention with the slideable panel in an extended position. The body (not shown) is attached to the laptop 23 display portion along edges 14 and 15. Tabs 20 extend inwardly from edges 14, 15 to clip over the perimeter of the laptop 23 display portion. The removable accessories 16 are shown removed from a rear of the body. Slideable panel 11 is shown in an extended position extending from a right (facing) side of the laptop 23. In this position, a first part of the slideable panel 11 extends beyond the body widthwise edge 15, while a portion of the panel remains within the spacing of the body. It should be understood that slideable panel 11 can also be extended from a left (facing) side of the laptop 23. The movement of the slideable panel 11 is indicated by the arrow.

A clip accessory 22 can be seen at a top of the slideable panel 11. The clip 22 is useful for securing a in place, or as a marker when viewing multiple pages. A holder accessory 21 is near the bottom of the slideable panel 11. The holder accessory 21 may be hingedly or otherwise attached to the slideable panel 11 and may swing out via the hinge to support one or more pages on the slideable panel 11. It should be understood that the page holder accessory 21 may operate in any manner capable of allowing pages or other flat items to rest thereon. In some embodiments, the holder accessory 21 may be used to hold a tablet computer or other portable computer display.

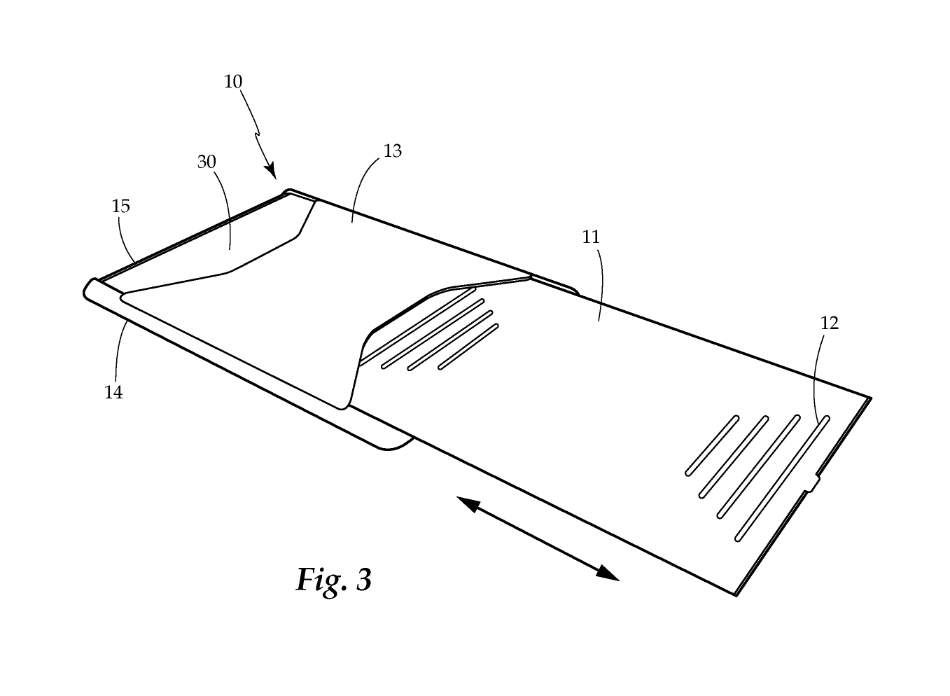

FIG. 3 provides a view of another embodiment of the present invention with the slideable panel in the extended position. This view shows a perspective view of the laptop cover 10. Body 13 has edges 14, 15 and defines the structure of the laptop cover 10. The body 13 extends over the slideable panel 11, defining a spacing channel for it, and holding it in place. A covering area 30 of the body 13 is exposed when the slideable panel 11 is moved to the extended position. In other embodiments however, the covering area 30 may be replaced with empty space, such that the edges 14, 15, define an aperture. As indicated by the arrow, slideable panel 11 may be slid in both directions depending on desires and intentions of the user.

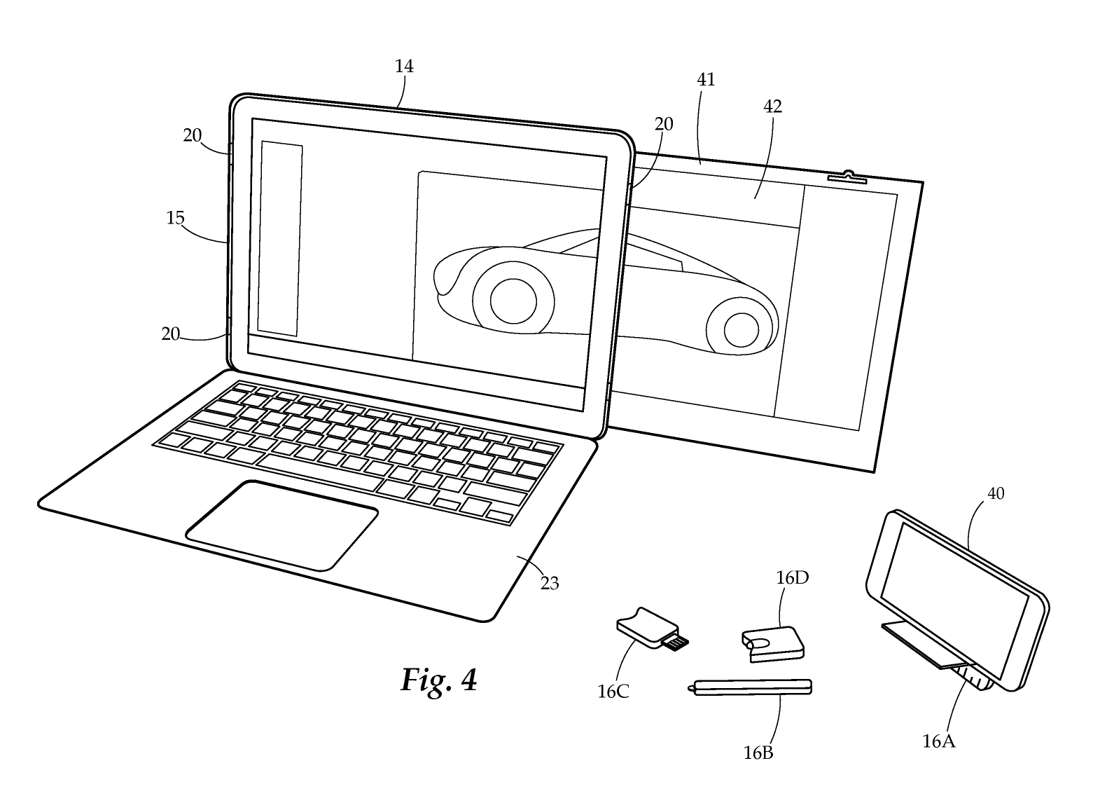

FIG. 4 provides a view of another embodiment of the present invention having a display integrated into the slideable panel. In this view, the body (not shown) is attached to the laptop 23 display portion along edges 14 and 15. Tabs 20 extend inwardly from edges 14, 15 to clip over the perimeter of the laptop 23 display portion. The removable accessories 16 are shown removed from a rear of the body. These accessories include a credit card reader 16a, stylus 16b, laser pointer 16c, and USB storage drive 16d. Credit card reader 16a is attached to a smartphone 40 or other equivalent mobile computing device. The credit card reader 16a may also be attachable to the laptop 23, in varying embodiments. In a similar embodiment, the credit card reader 16a may additionally (or alternatively—removing the card reading functionality) operate as a stand for the smart phone, such that the slot defined by the reader 16a is used to receive a credit card, allowing the phone screen to be held upright. Slideable panel 41 is shown in an extended position extending from a right (facing) side of the laptop 23. It should be understood that slideable panel 41 can also be extended from a left (facing) side of the laptop 23. The movement of the slideable panel 41 is indicated by the arrow.

Slideable panel 41 further comprises a computer display screen 42. The display screen 42 may be configured to display a continuation of the laptop screen in one embodiment. In another embodiment, the display screen 42 may be a separate display from the laptop display, and may operate as a standalone display screen. A connector (not shown) may connect display 42 to the laptop's 23 video output port, to another device's video output, and the like. In a particular embodiment having the display 42 be an extension of the laptop display, the laptop 23 may be programmed to automatically display an extension of the screen depending on how far the slideable panel 41 is extended. A sensor (not shown) may be in communication with the slideable panel 41 and the laptop 23 to identify a position of the slideable panel 41 allowing the laptop 23 processor to determine what should be displayed on the slideable panel. The display may accordingly adjust on the fly depending on positioning as determined by the sensor. This adjustment may be in the form of adjusting resolution, adjusting proportions, and/or adding/subtracting real estate on the display screen.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A laptop computer cover comprising:
a body, the body having lengthwise and widthwise edges, a portion of the body extending between the two lengthwise edges and extending upward between the edges to define a spacing between itself and the lengthwise and widthwise edges, the body being sized to fit on a display portion of a laptop;
a slideable panel slidably positioned within the spacing, the slideable panel slideable between a first position centered on the body in the spacing with no portion of the slideable panel extending beyond the widthwise edges, a second position having a first part of the slideable panel within the spacing and a second part of the slideable panel extending beyond one widthwise edge, and a third position having the first part of the slideable panel extending beyond the other widthwise edge, and the second part within the spacing, the slideable panel being slideable in two directions towards each of the opposite widthwise edges.

2. The laptop computer cover of claim 1 wherein the body tapers inward from the opposing lengthwise edges as it extends towards a center between the lengthwise and widthwise edges.

3. The laptop computer cover of claim 1 wherein the slideable panel comprises a hinged holder on a front surface, the hinged holder being movable about the hinge from a first position approximately aligned with the front surface of the slideable panel, to a second position approximately perpendicular with the front surface of the slideable panel.

4. The laptop computer cover of claim 1 wherein the slideable panel further comprises a textured area on opposing widthwise sides of a rear surface.

5. The laptop computer cover of claim 1 further comprising a multi-tool removably attached to the body, the multi-tool comprising a memory storage device, a laser pointer, and a smartphone stand.

6. A laptop computer comprising:
a display portion of the laptop housing a display;
a lower body part of the laptop hingedly connected to the display portion;
a laptop computer cover attached to the display portion, the laptop computer cover comprising:
a body, the body having lengthwise and widthwise edges, a portion of the body extending between the two lengthwise edges and extending upward between the edges to define a spacing between itself and the edges, the body being connected to the display portion;
a slideable panel slidably positioned within the spacing, the slideable panel slideable through the spacing between a first position centered on the body in the spacing with no portion of the slideable panel extending beyond the widthwise edges, a second position having a first part of the slideable panel within the spacing and a second part of the slideable panel extending beyond one widthwise edge, and a third position having the first part of the slideable panel extending beyond the other widthwise edge, and the second part within the spacing, the slideable panel being slideable in two directions towards each of the opposite widthwise edges.

7. The laptop computer of claim 6 wherein the lengthwise and widthwise edges comprise a plurality of inward protrusions, the plurality of inward protrusions connecting the laptop cover to the display portion of the laptop by being snap-fit to the display portion.

8. The laptop computer of claim 6 further comprising a lower body part cover, attached to the lower body part of the laptop and covering it.

9. The laptop computer of claim 6 wherein the cover slideable panel further comprises:
a hinged holder on a front surface, the hinged holder being movable about the hinge from a first position approximately aligned with the front surface of the slideable panel, to a second position approximately perpendicular with the front surface of the slideable panel.

10. The laptop of claim 9 further comprising a sheet of paper resting on the hinged holder in the second position and with the slideable panel in the second position.

11. The laptop computer of claim 9 further comprising a tablet computer resting on the hinged holder in the second position and with the slideable panel in the second position.

12. The laptop computer of claim 11 wherein the tablet computer is in electronic communication with the laptop.

13. The laptop computer of claim 6 wherein the cover further comprises:
a computer display positioned on a front surface of the slideable panel; and
a connector providing electronic communication between the computer display of the slideable panel and a display output the laptop.

14. The laptop computer of claim 6 wherein the slideable panel further comprises a textured area on opposing widthwise sides of a rear surface.

15. The laptop computer of claim 6 wherein the body tapers inward from the opposing lengthwise edges as it extends towards a center between the lengthwise and widthwise edges.

16. A laptop cover comprising:
a body, the body having lengthwise and widthwise edges, a portion of the body extending between the two lengthwise edges and extending upward between the edges to define a spacing between itself and the lengthwise and widthwise edges, the body being sized to fit on a display portion of a laptop;
a slideable panel slidably positioned within the spacing, the slideable panel slideable through the spacing between a first position centered on the body in the spacing with no portion of the slideable panel extending beyond the widthwise edges, a second position having a first part of the slideable panel within the spacing and a second part of the slideable panel extending beyond one widthwise edge, and a third position having the first part of the slideable panel extending beyond the other widthwise edge, and the second part within the spacing, the slideable panel being slideable in two directions towards each of the opposite widthwise edges;
a computer display positioned on a front surface of the slideable panel; and
a connector providing electronic communication between the computer display of the slideable panel and a display output the laptop.

17. The laptop cover of claim 16 wherein the body tapers inward from the opposing lengthwise edges as it extends towards a center between the lengthwise and widthwise edges.

18. The laptop cover of claim 1 wherein the slideable panel comprises a hinged holder on a front surface, the hinged holder being movable about the hinge from a first position approximately aligned with the front surface of the slideable panel, to a second position approximately perpendicular with the front surface of the slideable panel, the hinged holder being below the computer display of the front surface of the slideable panel.

19. The laptop cover of claim 1 wherein the slideable panel further comprising a textured area on opposing widthwise sides of a rear surface.

20. The laptop cover of claim 1 further comprising a multi-tool on the body, the multi-tool comprising a memory storage device, a laser pointer, and a credit card reader.
